(19) United States
(12) Patent Application Publication
(10) Pub. No.: US 2021/0274811 A1
(43) Pub. Date: Sep. 9, 2021

(54) Natural Water Essence and Methods of Making the Same

(71) Applicant: The Coca-Cola Company, Atlanta, GA (US)

(72) Inventors: Kalpesh Gandhi, Winter Garden, FL (US); Raymond Schacht, Apopka, FL (US); Marcelo Perez, Brandenton, FL (US); Hubertus Schubert, Smyrna, GA (US)

(73) Assignee: The Coca-Cola Company, Atlanta, GA (US)

(21) Appl. No.: 16/334,533

(22) PCT Filed: Sep. 19, 2017
(86) PCT No.: PCT/US2017/052214

§ 371 Date: Mar. 19, 2019

Related U.S. Application Data
(60) Provisional application No. 62/396,324, filed on Sep. 19, 2016.

(51) Int. Cl. A23L 2/08; A23L 2/56; A23L 2/72; A23L 2/46

(52) U.S. Cl. CPC A23L 2/082; A23L 2/46; A23L 2/72; A23L 2/56

(57) ABSTRACT

Beverage products including water collected from the condensation of fruit and vegetable juice are provided, along with methods of making the same. For example, natural fruit and vegetable flavored water beverages and method of making the same are provided.

### CROSS REFERENCE TO RELATED APPLICATIONS

This application claims the benefit of priority to U.S. Provisional Application No. 62/396,324, entitled “Natural Water Essence and Methods of Making the Same,” filed on Sep. 19, 2016, the entirety of which is hereby incorporated herein by reference.

### TECHNICAL FIELD

This disclosure relates to fruit and vegetable beverage products.

### BACKGROUND

Fruit and vegetable beverages, such as fruit and vegetable juices, not only have health benefits for consumers, due in part to their content of vitamins and antioxidant compounds, but are often preferred by consumers over flavorless water. However, some consumers may wish to avoid the caloric content of such fruit and vegetable beverages, and particularly the high content of naturally-occurring and/or added sugars in such fruit and vegetable beverages. Thus, developing zero or low calorie fruit and vegetable beverages has become an increasing priority in the food industry.

Consumers who wish to avoid the caloric content of fruit and vegetable beverages may wish to drink zero or low-calorie flavored water beverages. However, many consumers are dissatisfied with current flavored water beverage options, which typically have added flavors which consumers may perceive as artificial. As more consumers express preferences for “natural” beverage products, including flavored water beverages, developing zero or low-calorie fruit and vegetable beverages including flavored water beverages which contain only natural ingredients has become an increasing priority in the food industry.

### SUMMARY

This disclosure provides generally new beverages including water collected from the concentration of fruit and vegetable juices, and methods of making the same. Water collected from the concentration of fruits and vegetables presents a new source of water for beverage products, and may be used to produce fruit and vegetable flavored water beverages. These beverages may contain only natural ingredients, and may present a desirable flavored, low calorie beverage for consumers. The disclosed methods and products may be used with both ripe and unripe fruit and vegetables.

According to one aspect, for example, this disclosure provides a beverage product including water collected from the concentration of fruit or vegetable juice. The beverage may optionally contain fruit juice and/or natural flavors.

According to another aspect, for example, this disclosure provides a method of making a beverage product including the steps of: extracting juice from fruits or vegetables; separating the juice into a juice concentrate phase and a water vapor phase; and condensing the water vapor phase to produce a natural water essence including an oil phase and a water phase.

These and various other aspects and embodiments of this disclosure are illustrated in the drawings and detailed description that follow.

### BRIEF DESCRIPTION OF THE DRAWINGS

FIG. 1 is a simplified schematic of a process of making a natural water essence beverage according to an embodiment of the present disclosure.

### DETAILED DESCRIPTION

Aspects of this disclosure provide for new fruit and vegetable flavored beverages and methods of making the same. In one aspect, the disclosure provides for a flavored water product made from the water collected during the concentration of fruit and/or vegetable juice.

In some aspects, juice may be extracted from fruits or vegetables, and separated into a juice concentrate phase and a water vapor phase. This water vapor phase can then be condensed to produce a natural water essence. In one aspect, the disclosure provides for a flavored water product including natural water essence. In some aspects, this natural water essence can be separated into an oil phase and a water phase. In one aspect, the disclosure provides for a flavored water product including the water phase. In some aspects, the water phase can be filtered to remove particulates, and in some aspects may be filtered through a membrane filtration process, such as a nano-filtration process to provide a nano-filtered water phase. Then, in some aspects, fruit juice, vegetable juice, and/or other natural flavors are added to the nano-filtered water phase to form a beverage.

In certain instances, the fruit or vegetable juice is substantially derived from one or more fruits and one or more vegetables, respectively, by pressing. If desired, a combination of fruit and vegetable juice can be obtained by pressing one or more fruits and one or more vegetables together, or by combining their respective juices once pressed separately. The fruits and vegetables may be washed, stemmed, blanched, and then crushed, ground, or milled followed by mashing, enzyme treatment with heat. The enzyme treated fruits or vegetables may then be decanted as purée or pressed into juice.

In some instances, the juice or purée is then heated to form a juice concentrate. To form a juice concentrate, the juice or puree may be heated in a container to remove water from the juice or puree as steam or vapor, until a juice concentrate remains in the container, for example a concentrate of about 65 Brix, as would be understood by one of skill in the art. In some instances, the steam and vapor removed from the juice during the concentration process will contain numerous other components, including oils, volatiles, and other flavor compounds. In some embodiments, the steam and/or vapor removed from the juice during the concentration process is collected and condensed to form a natural water essence, which contains liquid water and volatile compounds from the fruits and vegetables. This steam and vapor may be condensed by any appropriate means, which would be known to one of skill in the art, for example by passing the steam and/or vapor through a cooling system.

In some embodiments, this natural water essence may be marketed as a natural fruit or vegetable flavored water beverage. In other embodiments, the natural water essence may be further separated into an oil phase, which may contain from about 90% to about 100% by weight natural oils and flavors, and a water phase, which may be substantially free of natural oils. In some embodiments, the water phase may contain from about 0% to about 10% by weight natural oils, for example, about 0 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, or any ranges therebetween. This separation may be performed through any suitable means which would be known to one of skill in the art, including but not limited to centrifugation. The natural oils and flavors collected from the oil phase may be separately packaged and sold, or may also be used in other beverage products. The water phase may then be further filtered and purified through suitable means, such as membrane filtration, to create a fruit or vegetable flavored water beverage. In some embodiments, fruit or vegetable juice, natural flavors, or colors may be added to create a fruit or vegetable flavored water beverage.

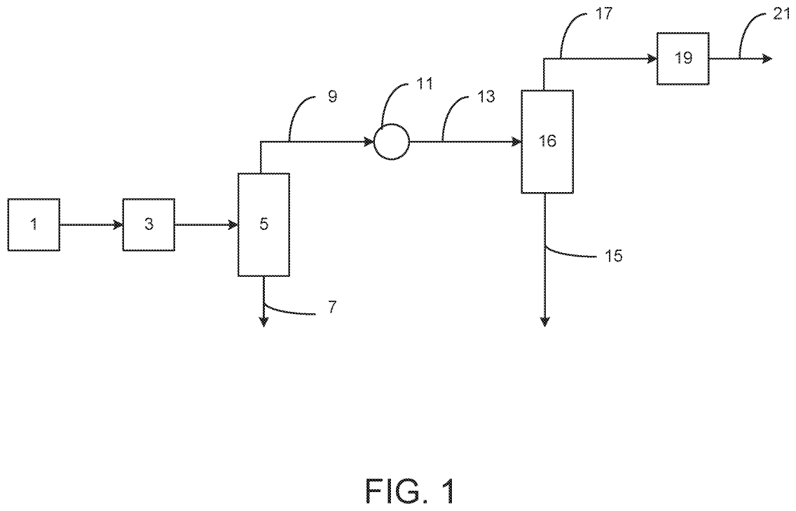

FIG. 1 is a simplified schematic of a process of making a beverage according to an embodiment of the present disclosure. First, fruits or vegetables 1 are processed through any suitable juice extraction means 3. In some embodiments, the extracted juice has a concentration of about 11.5 Brix. In some embodiments, the extracted juice has a concentration of from about 3 Brix to about 22 Brix, for example about 3 Brix, about 5 Brix, about 10 Brix, about 15 Brix, about 20 Brix, about 22 Brix, and any ranges therebetween. The extracted juice is then heated and concentrated through any suitable concentration means 5 to produce a juice concentrate phase 7 and a vapor phase 9, which contains steam, vapor, and volatile compounds from the extracted juice. Next, the vapor phase 9 is condensed through any suitable condenser 11 to produce a liquid natural water essence 13. In some embodiments, the condensation means 11 may be a cooling unit. The natural water essence 13 may then be separated through a separator 16, such as a centrifuge, to provide an oil phase 15, which contains oils and flavors from the fruit or vegetable juice, and a water phase 17. In some embodiments, the water phase 17 still contains at least some oils and flavors. The water phase 17 can then be filtered through a filter 19 to remove particulates, the water can be sanitized if desired either through filtration or other means known to those of skill in the art, and filtered water 21 is produced. This filtration and sanitation may occur through any suitable means. Finally, in some embodiments the filtered water may be bottled and sold.

In some aspects, fruit and vegetable juice may be added to the filtered water. For example, fruit and vegetable juice may be added in amounts from about 1% to about 30% by weight, for example about 1%, about 5%, about 10%, about 15%, about 20%, about 25%, about 30% by weight, or any ranges therebetween. In some embodiments, the fruit and vegetable juice added to the filtered water may be the same type as the fruit or vegetable juice from which the filtered water was derived. For example, in embodiments where the fruits or vegetables 1 are oranges, orange juice may be added in amounts from about 1% to about 30%, for example about 1%, about 5%, about 10%, about 15%, about 20%, about 25% about 30%, or any ranges therebetween. In some embodiments, the fruit and vegetable juice added to the filtered water may be a different type than the fruit or vegetable juice from which the filtered water was derived. For example, in embodiments where the fruits or vegetables 1 are oranges, mango juice may be added in amounts from about 1% to about 30%, for example about 1%, about 5%, about 10%, about 15%, about 20%, about 25% or about 30%.

In some aspects, natural flavors may be added to the filtered water. For example, natural flavors may be added in amounts from about 1% to about 30%, for example about 1%, about 5%, about 10%, about 15%, about 20%, about 25% or about 30% by weight. In some embodiments, the natural flavor added to the filtered water may be the same type as the fruit or vegetable from which the filtered water was derived. For example, in embodiments where the fruits or vegetables 1 are oranges, natural orange flavor may be added in amounts from about 1% to about 30%. In some embodiments, the natural flavor added to the filtered water may be a different type than the fruit or vegetable from which the filtered water was derived. For example, in embodiments where the fruits or vegetables 1 are oranges, natural mango flavor may be added in amounts from about 1% to about 30%, for example about 1%, about 5%, about 10%, about 15%, about 20%, about 25% about 30%, or any ranges therebetween.

In some aspects, both fruit and/or vegetable juice and natural flavors are added to the filtered water. For example, in some embodiments fruit and/or vegetable juice may be added in amounts from about 10% to about 20%, and natural flavors may be added in amounts from about 10% to about 20%. In some embodiments, the fruit and vegetable juice and natural flavors may be the same type as the fruit or vegetable from which the filtered water was derived. For example, in embodiments where the fruits or vegetables 1 are oranges, orange juice and natural orange flavor may each be added in amounts from about 10% to about 20%. In some embodiments, either or both of the fruit and vegetable juice and natural flavors may be a different type than the fruit or vegetable from which the filtered water was derived. For example, in embodiments where the fruits or vegetables 1 are oranges, orange juice and natural mango flavor may each be added in amounts from about 10% to about 20%.

In instances where the juice comprises a fruit juice, the fruit juice may be substantially derived from one or more fruits, in which the one or more fruits include ripe fruits, unripe fruits, or a combination thereof. Non-limiting examples of suitable fruits include plums, prunes, dates, currants, figs, grapes, red grapes, sweet potatoes, raisins, cranberries, pineapples, peaches, bananas, apples, peas, guavas, apricots, Saskatoon berries, blueberries, plains berries, prairie berries, mulberries, elderberries, choke cherries, coconuts, olives, raspberries, strawberries, huckleberries, loganberries, currants, dewberries, boysenberries, kiwi, cherries, blackberries, quinces, buckthorns, passion fruits, sloes, rowans, gooseberries, pomegranates, persimmons, mangos, rhubarbs, papayas, lychees, cashew apples, lemons, oranges, limes, tangerines, mandarin oranges, tangelos, pomelos, grapefruits, tomatoes, tomatillos, Kiwano melon, casaba melons, choke berries, watermelons, cantaloupes, honeydew melons, prickly pears, guanabanas (soursops), nectarines, tamarinds, ugli fruits, tangelos, wesos, yumberry, crabapples, carambolas (star fruits), marion berries, lingonberries (cowberries), young berries, dewberries, dalandans, calamansis, aloe, yuzus, mangosteens, huito fruits, durians, rambutans, dragon fruits, cherimoyas, goji berries, acais, Mexian hawthorns, feijoas, jackfruits, Jabuticabas, camucamus, kumquats, yuganzis, citrons, lulos (Naranjilla, kabosus), hornworts, natsumikans, palm fruits, and the like, and combinations thereof. Alternatively, some juices may be extracted from leaves, for instance extracts from mint leaves can provide a spearmint or peppermint taste.

In instances where the juice comprises a vegetable juice, the vegetable juice may be substantially derived from one or more vegetables, in which the one or more vegetables include ripe vegetables, unripe vegetables, or a combination thereof. Non-limiting examples of suitable vegetables include carrots, spinach, peppers, cabbage, sprouts, broccoli, potatoes, celery, anise (fennel), cucumbers, parsley, cilantro, beets, wheat grass, asparagus, zucchini, squash, rhubarb, turnips, rutabagas, parsnips, radishes, watercress, endive, escarole, lettuce, spinach, garlic, onion, ginger, carrots, yellow carrots, purple/black carrots, spinach, peppers, cabbage, red cabbage, sprouts, broccoli, potatoes, celery, anise (fennel), cucumbers, parsley, cilantro, beets, wheat grass, asparagus, zucchini, squash, rhubarb, turnips, rutabagas, parsnips, radishes, watercress, endive, escarole, lettuce, spinach, garlic, onion, ginger, artichokes, chicory, kohlrabi, yucca, collard greens, eggplant, green beans, mustard greens, summer squash, butternut squash, spaghetti squash, zucchini, peppermint, spearmint, curcumin, annatto, and the like, and combinations thereof. In addition, any one or more of the disclosed fruit juices and any one or more of the disclosed vegetable juices can be combined if desired and used according to this disclosure.

It should be understood that beverage products in accordance with the present disclosure may have any of numerous different specific formulations or constitutions. The beverage products disclosed herein may contain additional ingredients, including, generally, any of those typically found in beverage formulations. The formulation of a beverage product in accordance with this disclosure can vary to a certain extent, depending upon such factors as the product's intended market segment, its desired nutritional characteristics, flavor profile, and the like.

Non-limiting examples of suitable additional ingredients include, sweeteners, flavorings, electrolytes, vitamins, fruit or vegetable products (other than juice), tastants, preservatives, pH adjusting agents, enzymes, weighting agents, solvents, fruit or vegetable pulp, fruit and vegetable pieces, essential oils, masking agents and the like, flavor enhancers, color agents or dyes, antifoaming agents, gums, emulsifiers, cloud components, mineral and non-mineral nutritional supplements, antioxidants, purifiers, and/or carbonation, which typically can be added to any such juice products to vary the taste, mouthfeel, nutritional characteristics, etc.

It should be further noted that in certain instances, the present juice products undergo post-treatments. Non-limiting examples of suitable post-treatments include de-aeration, blanching, or addition of chemical agents for pH alteration such as citric, malic, or phosphoric acids, via addition of synthetic chelating agents such as EDTA, or via addition of synthetic sulfites or reducing agents or antioxidants, e.g., ethoxyquin, BHA, BHT, polyphenols, tocopherols.

### Definitions

To define more clearly the terms used herein, the following definitions are provided, and unless otherwise indicated or the context requires otherwise, these definitions are applicable throughout this disclosure. To the extent that any definition or usage provided by any document incorporated herein by reference conflicts with the definition or usage provided herein, the definition or usage provided herein controls.

The terms “a,” “an,” and “the” are intended, unless specifically indicated otherwise or the context requires otherwise, to include plural alternatives, e.g., at least one.

“Optional” or “optionally” means that the subsequently described event or circumstance can or cannot occur, and that the description includes instances where the event or circumstance occurs and instances where it does not.

When describing a range of measurements such as ratios, weight percentages, and the like, it is the Applicant's intent to disclose every individual number that such a range could reasonably encompass, for example, every individual number that has at least one more significant figure than in the disclosed end points of the range. As an example, when referring to a percentage from about 1% to about 20%, Applicant's intent is that the disclosure of this range also discloses and is equivalent to the disclosure of about 1%, about 2%, about 3%, about 4%, about 5%, about 6%, about 7%, about 8%, about 9%, about 10%, and so on, up to and including about 20%. Applicant's intent is that these two methods of describing the range are interchangeable. Moreover, when a range of values is disclosed or claimed, Applicant also intends for the disclosure of a range to reflect, and be interchangeable with, disclosing any and all sub-ranges and combinations of sub-ranges encompassed therein. Accordingly, Applicants reserve the right to proviso out or exclude any individual members of any such group, including any sub-ranges or combinations of sub-ranges within the group, that can be claimed according to a range or in any similar manner, if for any reason Applicants choose to claim less than the full measure of the disclosure, for example, to account for a reference that Applicants may be unaware of at the time of the filing of the application. Unless otherwise specified, a recited percentage is a weight percent.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed herein, and that each value is also herein disclosed as “about” that particular value in addition to the value itself. In aspects, “about” can be used to mean within 10% of the recited value, within 5% of the recited value, within 2% of the recited value, or within 1% of the recited value.

The term “natural flavors” means an essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional. Natural flavors may be derived from any suitable fruit, vegetable, or other edible product, including but not limited to aloe, althea root and flowers, amyris, angola weed, arnica flowers, Artemisia, artichoke leaves, benzoin resin, blackberry bark, boldus leaves, boronoia flowers, bryonia root, buchu leaves, buckbean leaves, cajeput, calumba root, camphor tree, cascara sagrada, cassie flowers, castor oil, catechu, cedar, centuary, cherry pits, cherry-laurel leaves, chestnut leaves, chirata, chincona, copaiba, cork, costmary, costus root, cubeb, currant, damiana, davana, dill, dittany, dragon's blood, elder tree leaves, elecampane rhizome and roots, elemi, erigeron, eucalyptus, fir needles and twigs, galangal, galbanum, gambir, genet flowers, gentian rhizome and roots, germander, guaiac, guarana, haw, hemlock needles and twigs, hyacinth flowers, Iceland moss, imperatorial, iva, labdanum, lemon-verbena, linaloe wood, linden leaves, lovage, lungmoss, maidenhair fern, maple, mimosa flowers, mullein flowers, myrrh, myrtyle leaves, oak, olibanum, opopanax, orris root, pansy, passion flower, patchouli, peach leaves, pennyroyal, pine, poplar buds, quassia, quebracho bark, quillaia, red saunders, rhatany root, rhubarb, roselle, rosin, St. Johnswort, sandalwood, sandarac, sarsaparilla, sassafras, senna, serpentaria, simaruba bark, snakeroot, spruce, storax, tagetes, tansy, thistle, thymus capitatus, tolu, turpentine, valerian rhizome and roots, veronica, vervain, vetiver, violet, walnut husks, leaves, and green nuts, woodruff, yarrow, yerba santa, yucca, and all those food products listed at 21 C.F.R. § 172.510, which is hereby incorporated herein.

The term “substantially free” of a particular compound or class of compounds means that the compositions of the present disclosure contain less than about 10 percent of the recited compound or class of compounds, or alternatively, less than about 5 percent, less than about 2 percent, or less than about 1 percent by weight.

Any headings that are employed herein are not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

Applicants reserve the right to proviso out any selection, feature, range, element, or aspect, for example, to limit the scope of any claim to account for a prior disclosure of which Applicants may be unaware.

1. A beverage product comprising:
water collected from the concentration of fruit or vegetable juice.

2. The beverage product of claim 1, further comprising juice.

3. The beverage product of claim 1, further comprising from about 1% by weight to about 30% by weight juice.

4. The beverage product of claim 1, further comprising fruit or vegetable juice concentrate.

5. The beverage product of claim 1, further comprising from about 1% by weight to about 30% by weight natural flavors.

6. The beverage product of claim 1, wherein the water collected from the concentration of fruit or vegetable juice is filtered.

7. The beverage product of claim 1, wherein the water collected from the concentration of fruit or vegetable juice does not contain particulate matter.

8. A method of making a beverage product comprising the steps of:
extracting juice from fruits or vegetables;
separating the juice into a juice concentrate phase and a water vapor phase; and
condensing the water vapor phase to produce a natural water essence comprising an oil phase and a water phase.

9. The method of claim 8, further comprising the steps of:
separating the natural water essence into an oil phase and a water phase; and
filtering the water phase.

10. The method of claim 9, wherein the step of filtering the water phase comprises:
filtering the water phase to remove particulate matter.

11. The method of claim 9, wherein the step of filtering the water phase comprises:
filtering the water phase to remove particulates to provide a particulate-free water phase; and
filtering the particulate-free water phase through a nano-filtration process to provide a nano-filtered water phase.

12. The method of claim 11, wherein the nano-filtration process comprises filtration through an activated carbon filter.

13. The method of claim 12, wherein the nano-filtered water phase is pasteurized.

14. The method of claim 12, wherein the nano-filtered water phase is heat-treated.

15. The method of claim 9, further comprising the steps of:
adding fruit or vegetable juice to the water phase.

16. The method of claim 9, further comprising the steps of:
adding from about 1% by weight to about 30% by weight juice to the water phase.

17. The method of claim 9, further comprising the step of:
adding natural flavors to the water phase.

18. The method of claim 9, further comprising the step of:
adding from about 1% by weight to about 30% by weight natural flavors to the water phase.

19. The method of claim 9, further comprising the step of:
adding juice and natural flavors in a combined weight percentage of from about 5% by weight to about 40% by weight.
